(19) United States
(12) Patent Application Publication
(10) Pub. No.: US 2006/0250341 A9
(43) Pub. Date: Nov. 9, 2006

(54) Display driving device and display apparatus comprising the same

(75) Inventor: Takahiro Harada, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD, Tokyo (JP)

(21) Appl. No.: 11/317,520

(22) Filed: Dec. 23, 2005

(30) Foreign Application Priority Data
Dec. 28, 2004 (JP) 2004-380428

(51) Int. Cl. G09G 3/36

(52) U.S. Cl. 345/89

(57) ABSTRACT

A display driving device includes a gradation voltage generating section for generating a plurality of gradation voltages corresponding to the number of gradation levels in display data and reversing polarities of the gradation voltages at a time based on a horizontal synchronizing signal corresponding to the display data. A plurality of applying circuit sections are provided for every predetermined number of a plurality of signal lines, for generating a display signal voltage corresponding to the display data on the basis of the plurality of gradation voltages and for sequentially applying the display signal voltage to each of the predetermined number of signal lines. The time when the gradation voltage generating section reverses the polarities of the gradation voltages is set to occur before a timing for the next horizontal synchronizing signal and after completion of application of the display signal voltage to the signal lines.

### CROSS-REFERENCE TO RELATED APPLICATIONS

This application is based upon and claims the benefit of priority from prior Japanese Patent Application No. 2004-380428, filed Dec. 28, 2004, the entire contents of which are incorporated herein by reference.

### BACKGROUND OF THE INVENTION

1. Field of the Invention

The present invention relates to a display driving device and a method for drivingly controlling the display driving device, as well as a display apparatus comprising the display driving device. In particular, the present invention relates to a display driving device that applies a display signal voltage based on a plurality of gradation voltages to each signal line of a display panel to display an image on the display panel, and a method for drivingly controlling the display driving device, as well as a display apparatus comprising the display driving device.

2. Description of the Related Art

In recent years, liquid crystal display apparatuses have been frequently used in image pickup equipment such as digital video cameras and digital still cameras and portable equipment such as cellular phones and portable information terminals (PDA), as displays that display images, text information, and the like; the image pickup equipment and portable equipment have prevailed markedly. Liquid crystal display apparatuses have also been frequently used as information terminals for computers, or monitors or displays for image display equipment such as televisions. Liquid crystal display apparatuses for such applications are thin and light and enable their own power consumption to be reduced. These liquid crystal display apparatuses also exhibit high display image quality.

As a liquid crystal display panel for such a liquid crystal display apparatus, an active matrix system is often used which has a plurality of scan lines and a plurality of signal lines which cross at right angles. In this system, a liquid crystal pixel is placed at each of the intersecting points between the scan lines and signal lines. In such an active matrix type liquid crystal display panel, a liquid crystal is filled between pixel electrodes (display pixels) each connected to each signal line via a switching element (for example, TFT: Thin Film Transistor) and a common electrode placed opposite the pixel electrode. An electric field is formed between the both electrodes to drive the liquid crystal.

A liquid crystal display apparatus comprising such an active matrix type liquid crystal display panel has, for example, an RGB decoder that extracts R, G, and B color display data from an externally supplied video signal (composite video signal) and a signal driver that applies, to each signal line, a display signal voltage corresponding to a display data signal based on the display data output by the RGB decoder.

If the display data is a digital signal, such a signal driver comprises a gradation voltage generating circuit that generates a plurality of gradation voltages required to generate a display signal voltage. Further, since the liquid crystal is reversely driven, the potentials of the gradation voltages have their polarities reversed at predetermined periods. Then, one of the plurality of gradation voltages is selected on the basis of the gradation value in the display data. A display signal voltage based on the selected gradation voltage is then applied to each signal line.

On the other hand, the following technique is known: if the number of signal lines increases as a result of an improvement in the definition of the liquid crystal panel, the signal driver for the liquid crystal display apparatus drives the liquid crystal display in a time division manner by dividing the plurality of signal lines into a plurality of groups, outputting corresponding display signal voltages in a time division manner, and applying the voltages to the respective groups of signal lines while sequentially switching the applied voltage.

In a signal driver comprising such a gradation voltage generating circuit as described above, each gradation voltage applying line is provided with a plurality of switch elements corresponding to the signal lines. These switch elements are provided in order to select one of a plurality of gradation voltages generated by the gradation voltage generating circuit and to apply the selected gradation voltage to the corresponding signal line. Transistors or the like are used as these switch elements. A large number of transistors are thus provided on each gradation voltage applying line to increase the total load carrying capacity of the large number of transistors. Thus, when the polarities of potentials of the gradation voltages are reversed, a certain time is required to stabilize (converge) the potentials of the gradation voltage applying lines to a predetermined value.

With a signal driver comprising such a gradation voltage generating circuit, if time division driving such as that described above is applied, the application time for which the display signal voltage is applied to each signal line during one horizontal scan period (write time) decreases depending on the number of divisions. In addition, if a certain time is required to stabilize the potentials of the gradation voltages to the predetermined value after the polarities of the potentials have been reversed, a decrease occurs in the application time, that is, the write time, for which the display signal voltage is initially applied to the signal line after the potentials of the gradation voltages have been stabilized. This may degrade display image quality.

Further, if the driving capability of the signal driver is enhanced to enable the gradation voltage to be sufficiently applied to each signal line within such a short application time, the power consumption of the signal driver disadvantageously increases.

### BRIEF SUMMARY OF THE INVENTION

The present invention provides a display driving device that drives, on the basis of display data, a display panel having a plurality of display elements each arranged near an intersecting point between a corresponding one of a plurality of signal lines and a corresponding one of a plurality of scan lines, as well as a display apparatus comprising the display driving device. The present invention has the advantage of being able to suppress degradation of display image quality and to eliminate the need to increase the number of display driving devices.

According to an aspect of the present invention, there is provided a display driving device which drives a display panel on the basis of display data, the display panel having a plurality of display pixels arranged in a matrix manner adjacent to intersections of a plurality of signal lines and a plurality of scanning lines, the display driving device comprising:

a gradation voltage generating section for generating a plurality of gradation voltages corresponding to the number of gradation levels in the display data and reversing polarities of the gradation voltages at a time based on a horizontal synchronizing signal corresponding to the display data; and

an applying circuit section provided for every predetermined number of the plurality of signal lines, for generating a display signal voltage corresponding to the display data on the basis of the plurality of gradation voltages and for sequentially applying the display signal voltage to each of the predetermined number of signal lines,

wherein the time when the gradation voltage generating section reverses the polarities of the gradation voltages is set to occur before a timing for the next horizontal synchronizing signal and after completion of application of the display signal voltage to the plurality of signal lines.

Preferably, the time when the gradation voltage generating section reverses the polarities of the gradation voltages is set to occur after completion of application of the display signal voltage to the plurality of signal lines and before a predetermined gradation voltage convergence time when voltage values of the gradation voltages converge after reversal of polarities of the gradation voltages following the timing for the next horizontal synchronizing signal.

The display driving device may comprise a data holding section for loading and holding the display data in parallel, wherein the applying circuit sections comprises a first switch circuit section for sequentially selecting each of the predetermined number of display data held in parallel in the data holding section, in accordance with the horizontal synchronizing signal, a display signal generating section for selecting one of the plurality of gradation voltages on the basis of a gradation value in the display data to generate the display signal voltage, and a second switch circuit section for sequentially selecting each of the predetermined number of signal lines in accordance with the horizontal synchronizing signal and sequentially applying the display signal voltage corresponding to the display data selected by the first switch circuit section to every predetermined number of signal lines selected, the display signal voltage being generated by the display signal generating section.

The second switch circuit section preferably has a period during which all the plurality of signal lines are set in a selected state, before one of the predetermined number of signal lines is selected.

According to a second aspect of the present invention, there is provided a display apparatus which displays image information based on a video signal, on a display panel having a plurality of display pixels arranged in a matrix manner adjacent to intersections of a plurality of signal lines and a plurality of scanning lines, the display apparatus comprising:

a scan driving circuit for sequentially outputting a scan driving signal to the plurality of scan lines to sequentially set the display pixels in a selected state;

a polarity reversal signal generating section for outputting a reversal signal having a polarity reversed at a time corresponding to a horizontal synchronizing signal based on the video signal; and

a signal driving circuit comprising a gradation voltage generating section for generating a plurality of gradation voltages corresponding to the number of gradation levels in display data based on the video signal and reversing polarities of the gradation voltages in response to a polarity reversal timing in the reversal signal, and an applying circuit section for every predetermined number of the plurality of signal lines, for generating a display signal voltage corresponding to the display data on the basis of the plurality of gradation voltages and for sequentially, applying the display signal voltage to each of the predetermined number of signal lines,

wherein the time when the polarity reversal signal generating section reverses the reversal signal is set to occur before a timing for the next horizontal synchronizing signal and after completion of application of the display signal voltage to the plurality of signal lines.

Preferably, the time when the polarity reversal signal generating section reverses the reversal signal is set to occur after the applying circuit section completes applying the display signal voltage to the plurality of signal lines and before a predetermined gradation voltage convergence time when voltage values of the gradation voltages converge after reversal of polarities of the gradation voltages following the timing for the next horizontal synchronizing signal.

The signal driving circuit may comprise data holding section for loading and holding the display data in parallel, wherein the applying circuit section comprises a first switch circuit section for sequentially selecting each of the predetermined number of display data held in parallel in the data holding section, in accordance with the horizontal synchronizing signal, a display signal generating section for selecting one of the plurality of gradation voltages on the basis of a gradation value in the display data to generate the display signal voltage, and a second switch circuit section for sequentially selecting each of the predetermined number of signal lines in accordance with the horizontal synchronizing signal and sequentially applying the display signal voltage corresponding to the display data selected by the first switch circuit section to every predetermined number of signal lines selected.

According to a third aspect of the present invention, there is provided a method for drivingly controlling a display driving device which drives a display panel on the basis of display data, the display panel having a plurality of display pixels arranged in a matrix manner adjacent to intersections of a plurality of signal lines and a plurality of scanning lines, the method comprising:

generating a plurality of gradation voltages corresponding to the number of gradation levels in the display data;

generating a display signal voltage corresponding to the display data based on the plurality of gradation voltages;

sequentially applying the display signal voltage to each of the predetermined number of signal lines, reversing the polarities of the gradation voltages before a timing for the next horizontal synchronizing signal and after completion of application of the display signal voltage to the plurality of signal lines.

Said generating the display signal voltage may comprise loading and holding the display data in parallel, sequentially selecting each of the predetermined number of display data held, in accordance with the horizontal synchronizing signal, and selecting one of the plurality of gradation voltages on the basis of a gradation value in the display data to generate the display signal voltage, and

said sequentially applying the display signal voltage to each of a predetermined number of the plurality of signal lines comprises sequentially selecting each of the predetermined number of signal lines in accordance with the horizontal synchronizing signal and sequentially applying the display signal voltage to every predetermined number of signal lines selected.

### BRIEF DESCRIPTION OF THE SEVERAL VIEWS OF THE DRAWING

FIG. 1 is a block diagram showing the configuration of a liquid crystal display apparatus in accordance with an embodiment of the present invention;

FIG. 2 is a diagram showing an equivalent circuit for a display pixel of the display apparatus in accordance with the embodiment of the present invention;

FIG. 3 is a diagram showing the configuration of a part of a signal driver of the display apparatus in accordance with the present invention;

FIG. 4 is a circuit diagram of a gradation voltage generating section and a DAC circuit section of the display apparatus in accordance with the present embodiment;

FIGS. 5A and 5B are timing charts showing signal waveforms of main signals for a conventional liquid crystal display device; and

FIGS. 6A and 6B are timing charts showing signal waveforms of main signals for the liquid crystal display apparatus in accordance with the present embodiment.

### DETAILED DESCRIPTION OF THE INVENTION

A detailed description will be given below of a display driving device, a method for drivingly controlling the display driving device, and a display apparatus comprising the display driving device, by showing embodiments.

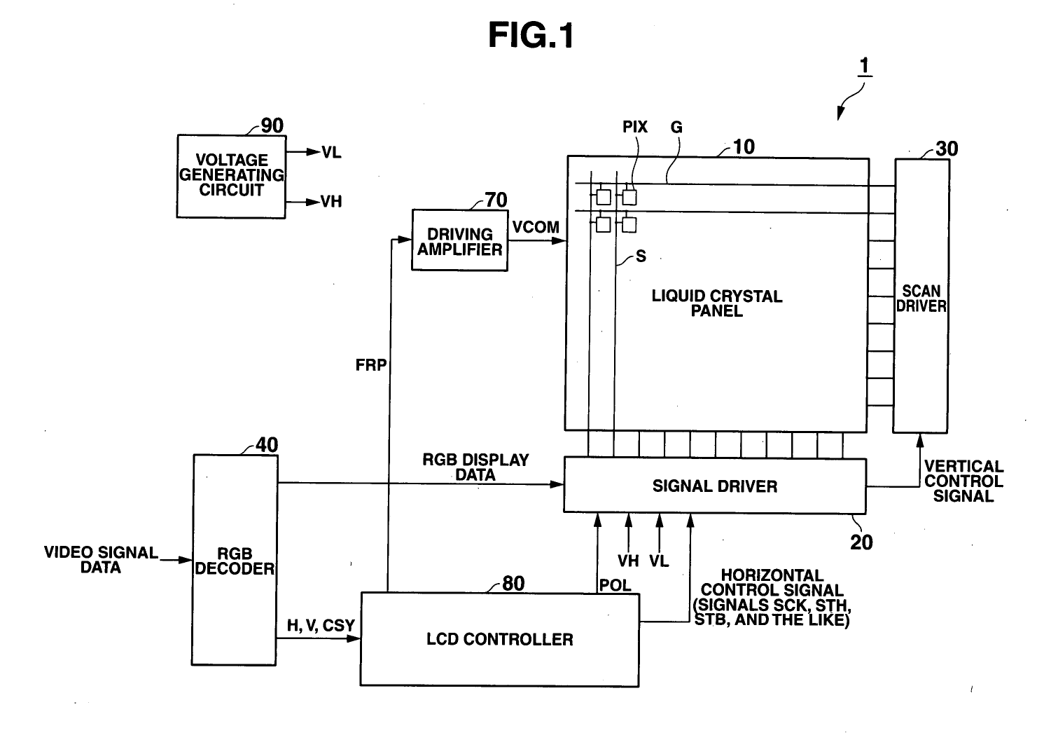

FIG. 1 is a block diagram showing the configuration of a liquid crystal display apparatus in accordance with an embodiment of the present invention.

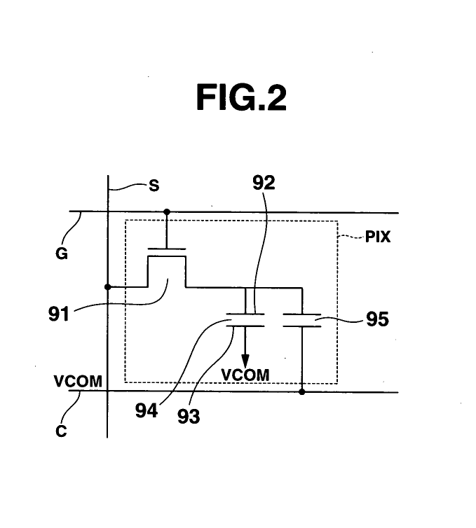

FIG. 2 shows an equivalent circuit for a display pixel in accordance with an embodiment of the present invention.

A liquid crystal display apparatus 1 has a liquid crystal display panel 10 (display panel), a signal driver (signal driving circuit) 20, a scan driver (scab driving circuit) 30, an RGB decoder (horizontal synchronizing signal generating section) 40, a driving amplifier 70, an LCD controller (polarity reversal signal generating section) 80, a voltage generating circuit 90.

The signal driver 20 in accordance with the present invention is based on a time division driving system and carries out three-division driving in the description below. However, the present invention is not limited to this but the signal driver 20 may have another number of divisions.

The liquid crystal display panel 10 comprises a plurality of scan lines G arranged across rows, a plurality of signal lines S disposed across columns, and display pixels PIX each arranged near the intersecting point between the corresponding scan line G and signal line S and shown in FIG. 2.

Each display pixel PIX is composed of a pixel electrode 92 connected to the scan line G and signal line S via a thin film transistor (TFT) 91, an opposite or counter electrode 93 placed opposite the pixel electrode 92, a pixel capacity 94 placed between the pixel electrode 92 and the opposite electrode 93 and into which a liquid crystal is filled, and an auxiliary capacity 95 connected in parallel with the pixel to hold a voltage applied to the pixel capacity 94. An image is displayed by using a change in the alignment of the liquid crystal caused by an electric field formed between the pixel electrode 92 and the opposite electrode 93.

The signal lines S are connected to the signal driver 20. On the basis of horizontal control signals (clock signal SCK, shift start signal STH, latch operation control signal STB, and the like), the signal driver 20 stores display data for colors R (red), G, (green), and B (blue) supplied by the RGB decoder 40, in each row. The signal driver 20 then sequentially supplies each signal line S with display signal voltages based on the display data. This will be described below in detail.

The scan lines G are connected to the scan driver 30. On the basis of vertical control signals output by the LCD controller 80, the scan driver 30 sequentially applies scan signals to each scan line G to select it. The scan driver 30 then applies the display signal voltage supplied by the signal driver 20 via the signal line S, to the display pixel PIX (pixel electrode) located at the intersecting point between this scan line G and the corresponding signal line S.

The RGB decoder 40 extracts a horizontal synchronizing signal H, a vertical synchronizing signal V, and a composite synchronizing signal CSY from a video signal (composite video signal) supplied by, for example, an apparatus located outside the liquid crystal display apparatus 1. The RGB decoder 40 then supplies the extracted signals to the LCD controller 80. Further, the RGB decoder 40 extracts RGB display data based on R, G, and B color signals contained in the video signal to obtain a digital signal, which is then output to the signal driver 20.

The driving amplifier 70 generates a common signal voltage VCOM applied to the opposite electrode 93 and to an auxiliary capacity line (common line) C connected to an auxiliary capacity 31 for each display element. The driving amplifier 70 reverses the polarity of the common signal voltage VCOM in accordance with a polarity reversal control signal FRP output by the LCD controller 80. The driving amplifier 70 then outputs the voltage with the reversed polarity.

According to the horizontal synchronizing signal H, vertical synchronizing signal V, and composite synchronizing signal CSY supplied by the RGB decoder 40, the LCD controller 80 generates and outputs a polarity control signal POL and the like to the signal driver 20 and the driving amplifier 70. The LCD controller 80 also generates and outputs horizontal control signals and vertical control signals to the signal driver 20 and the scan driver 30. The LCD controller 80 thus applies a gradation voltage to each display pixel PIX at a predetermined time to perform control such that the liquid crystal display panel 10 displays predetermined image information based on the display data.

The voltage generating circuit 90 generates and supplies a plurality of voltages required for circuits constituting the liquid crystal display apparatus 1. For example, a gradation voltage generating section 28 in the signal driver 20, described later, generates and supplies voltages VH, VL, and the like required to generate a gradation voltage, to the signal driver 20.

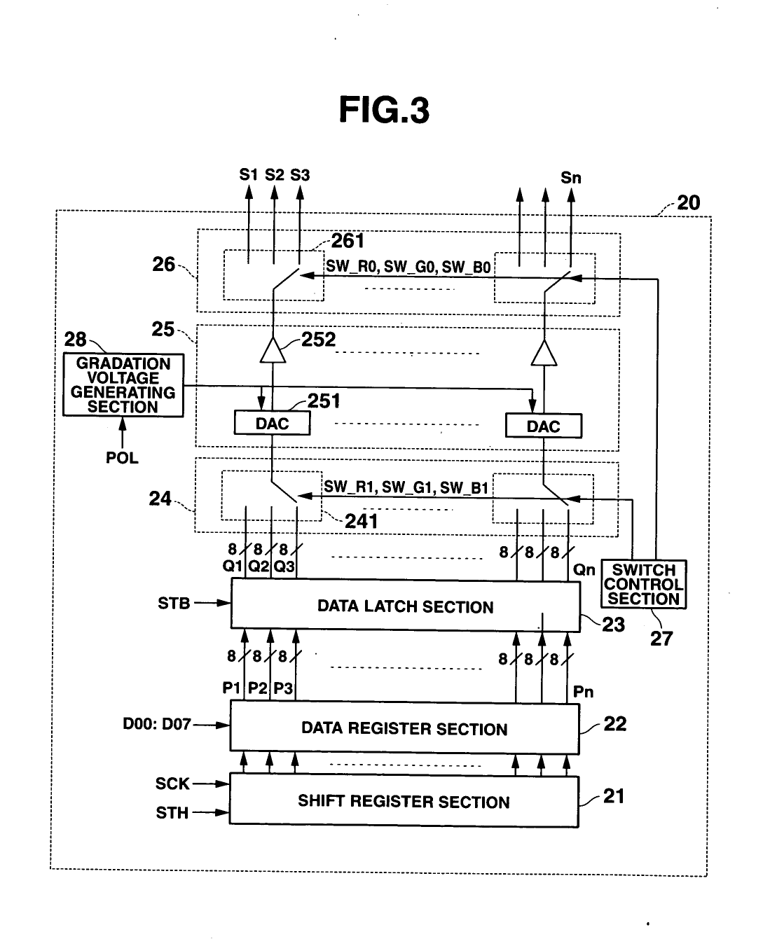

FIG. 3 is a diagram showing the configuration of a part of an embodiment of the signal driver in accordance with the present invention.

The signal driver 20 includes a shift register section 21, a data register section (data holding circuit) 22, a data latch section 23, a first switch circuit section (first switch circuit) 24, a DAC circuit section (display signal generating circuit) 25, a second switch circuit section (second switch circuit) 26, a switch control section 27, and a gradation voltage generating section (gradation voltage generating circuit) 28.

The shift register section 21 sequentially shifts the input shift start signal STH on the basis of a clock signal SCK. The shift register section 21 then outputs a timing signal obtained to the data register section 22.

Display data of a bits (for example, in FIG. 3, D00 to D07 consisting of a=8 bits) is input to the data register section 22. The data register section 22 sequentially loads the display data every time the shift register section 21 inputs a signal to the data register section 22.

The data latch section 23 loads all the display data P1, P2, . . . , and Pn in accordance with the input latch operation control signal. The data latch section 23 outputs the loaded display data P1, P2, . . . , and Pn to the DAC circuit section 25 via the first switch circuit section 24 as display data Q1, Q2, . . . , and Qn.

The DAC circuit section 25 is composed of a plurality of DAC sections 251 and a plurality of output amplifier sections 252. The DAC section 251 selects one of the gradation voltages supplied by the gradation voltage generating section 28 to convert the display data Q1, Q2, . . . , and Qn into corresponding analog signals. The DAC section 251 then outputs the resulting display signal voltages via an output amplifier circuit (buffer circuit) 252. The voltages are applied to signal lines S1, S2, . . . , and Sn via the second switch circuit section 26.

Now, a detailed description will be given of the first switch circuit section 24 and the second switch circuit section 26. The first switch circuit section 24 is composed of a plurality of first switch groups 241 each having a plurality of switches. The second switch circuit section 26 is composed of a plurality of second switch groups 261 each having a plurality of switches. The first switch circuit section 24 and the second switch circuit section 26 are drivingly controlled by signals output by the switch control section 27. The first and second switch circuit sections 24, 26 thus apply the display data signal in a time division manner.

The first switch circuit section 24 includes one first switch group 241 for every m (m is an integer equal to or larger than 2; in FIG. 3, m=3) of the plurality of display data output lines output by the data latch section 23. Each first switch group 241 selects one of the m display data output lines and connects it to one DAC section 251.

Further, the second switch circuit section 26 similarly includes one second switch group 261 for every m of the plurality of signal lines S in the liquid crystal display panel 10. Each second switch group 261 selects one of the m signal lines and applies a gradation voltage to this signal line S. The gradation voltage is the display data signal output by the output amplifier circuit 252.

The switch control section 27 outputs first switch control signals SW_R1, SW_G1, and SW_B1 to the first switch groups 241. The switch control section 27 also outputs second switch control signals SW_R0, SW_G0, and SW_B0 to the second switch groups 261. The switch control section 27 thus uniformly sets a connection state for the first switch groups 241 and second switch groups 261 so that the switch groups can operate synchronously. Further, the switch control section 27 controls the first switch circuit section 24 and the second switch circuit section 26 by outputting the first switch control signals SW_R1, SW_G1, and SW_B1 and the second switch control signals SW_R0, SW_G0, and SW_B0 so that the connection state is sequentially established for the first switch groups 241 and second switch groups 261 during one scan period (for example, one horizontal scan period).

The first switch control signals SW_R1, SW_G1, and SW_B1 are associated with any of the m display data output lines connected to the first switch group 241. A switching operation is performed so that one of the first switch signals is turned on during one scan period to connect the display data output line associated with the turned-on first switch signal to the DAC circuit section 25.

The second switch control signals SW_R0, SW_G0, and SW_B0 are associated with any of the m signal lines connected to the second switch group 261. A switching operation is performed so that the second switch control signals SW_R0, SW_G0, and SW_B0 are sequentially turned on during one scan period to connect the signal line S associated with the turned-on second switch control signal to an output end of the output amplifier circuit 252.

Thus, the signal driver carries out time division driving so as to divide an operation of applying a display data signal to each signal line S in the liquid crystal display panel 10, into m portions for one scan period. In this case, the number of DAC sections 251 or output amplifier circuits 252 constituting the DAC circuit section 25 is the same as that of first switch groups 241 or second switch groups 261 constituting the second switch circuit section 26. This number is 1/m of that of signal lines S.

Now, description will be given of the DAC circuit section 25 and the gradation voltage generating section 28.

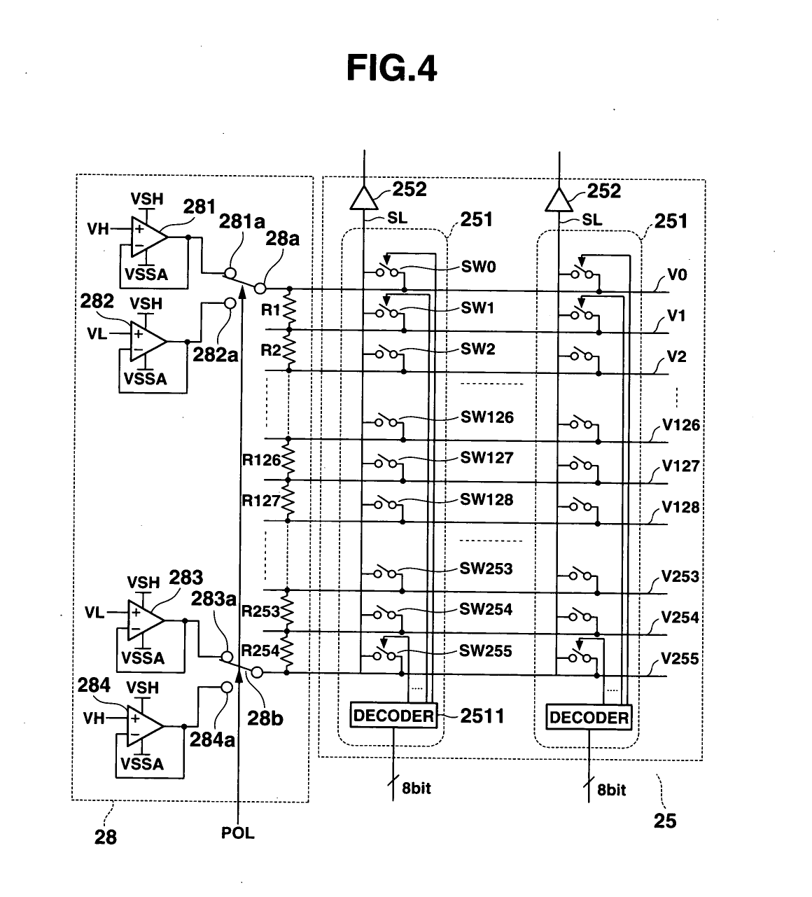

FIG. 4 is a diagram showing an example of the circuit configuration of the DAC circuit section and gradation voltage generating section in accordance with the present embodiment.

The gradation voltage generating section 28 divides the range of voltage between voltages VH and VL using a plurality of resistors R1, R2, . . . , and R254 corresponding to the number of gradation levels (=2^{a}; for example, in FIG. 4, 2⁸=256 gradation levels) in the display data. The gradation voltage generating section 28 applies the voltages obtained to gradation voltage applying lines V0, V1, . . . , and V255 as gradation voltages.

Specifically, the voltage generating circuit 90 supplies the voltage VH to amplifiers 281 and 284. The amplified voltage is then applied to terminals 281a and 284a. Further, the voltage generating circuit 90 supplies the voltage VL to amplifiers 282 and 283. The amplified voltage is then applied to terminals 282a and 283a. A switch 28a carries out switching to select the terminal 281a or 282a in accordance with the polarity control signal POL, output by the LCD controller 80. A switch 28b carries out switching to select the terminal 283a or 284a in accordance with the polarity control signal POL. In this case, the switches 28a and 28b select the terminals 281a and 283a at the same time and select the terminals 282a and 284a at the same time. Thus, when the voltage VH is applied to the gradation voltage applying line V0, the voltage VL is applied to the gradation voltage applying line V255. When the voltage VL is applied to the gradation voltage applying line V0, the voltage VH is applied to the gradation voltage applying line V255. In this manner, the gradation voltage applying lines V0 and V255 receive the voltages having their polarities reversed depending on the polarity reversal in the polarity control signal POL. At the same time, the polarities of the voltages of the gradation voltage applying lines V1 to V254 are reversed.

The DAC section 251 comprises a decoder 2511 and selection switches SW0, SW1, . . . , and SW255 connected to the gradation voltage applying lines V0, V1, . . . , and V255. Display data output by the first switch group is input to the decoder 2511, which then decodes the data to output a gradation level signal corresponding to the number of gradation levels for each of the R, G, and B pixels. The select switches SW0, SW1, . . . , and SW255 are controllably turned on and off on the basis of the gradation level signal output by the decoder 2511. The selected one of the gradation voltage applying lines V0, V1, . . . , and V255 is electrically connected to a gradation voltage output line SL to apply the gradation voltage applied to that gradation voltage applying line, to the gradation voltage output line SL. That is, the gradation voltage of the selected one of the gradation voltage applying lines V0, V1, . . . , and V255 is applied to the gradation voltage output line SL, which then outputs the voltage to the second switch group 261 via the output amplifier circuit 252.

Now, description will be given of a method for drivingly controlling the liquid crystal display apparatus 1 in accordance with the present embodiment. The effects of the present invention will be described in detail in comparison with those of a conventional method for driving control.

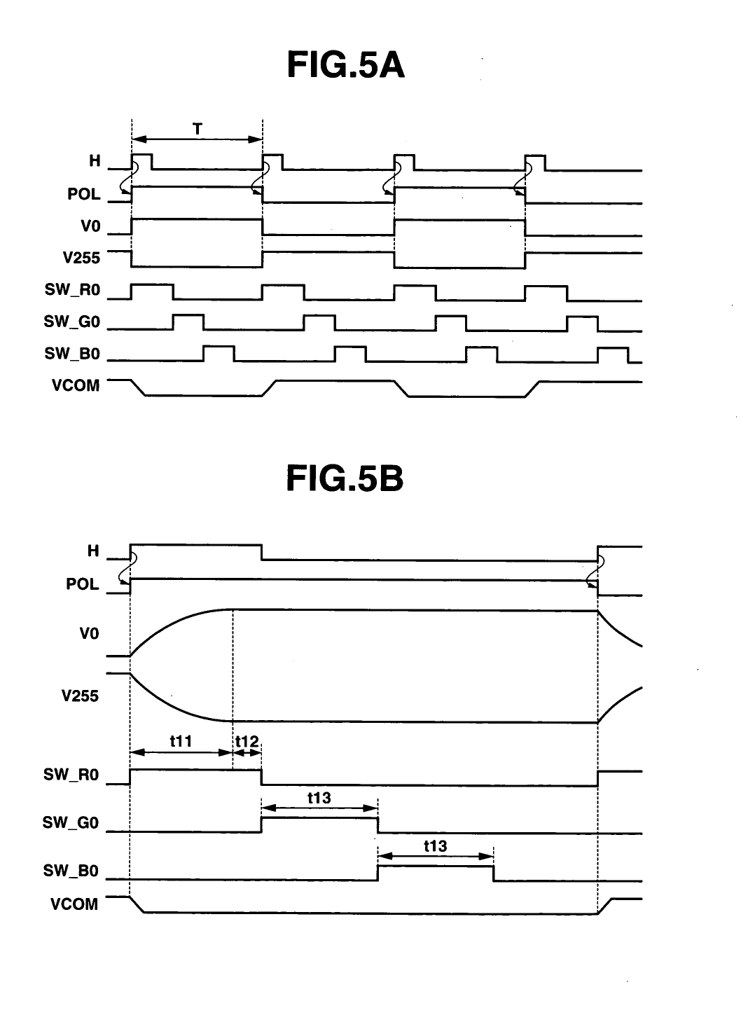

FIG. 5A is a diagram showing the signal waveforms of main signals in a conventional liquid crystal display apparatus.

FIG. 5B is an enlarged view of a time T (one horizontal scan period between the output of a horizontal synchronizing signal H and the output of the next one) in FIG. 5A.

In these figures, an abscissa shows a time axis. The figures show the voltage waveforms of the horizontal synchronizing signal H, the polarity control signal POL, the voltage V0 applied to gradation voltage applying line, the voltage V255 applied to the gradation voltage applying line, the second switch control signals SW_R0, SW_G0, and SW_B0, and the common signal voltage VCOM in this order from top to bottom.

In FIG. 5B, the polarity of the polarity control signal POL is reversed in response to and simultaneously with a rise in the horizontal synchronizing signal H. Moreover, the second switch control signal SW_R0 changes to a high level. A gradation voltage as a display data signal is applied to the signal line S corresponding to the second switch control signal SW_R0. Then, the second switch control signal SW_G0 is selected and changes to the high level. The second switch control signal SW_B0 is then selected and changes to the high level. A selected gradation voltage is sequentially applied to the corresponding signal line S as a display data signal.

However, as shown in FIG. 5B, a time t11 is required to stabilize the polarities of the potentials of the gradation voltage applying lines V0 and V255 after reversal in accordance with the polarity reversal in the polarity control signal POL. This is because the large number of selection switches SW1, SW2, . . . , and SW255, composed of transistors, are connected to one gradation voltage applying line, thus constituting the large load carrying capacity of the gradation voltage applying line. Consequently, when the potentials of the gradation voltages are changed by polarity reversal, a long time is required to stabilize (converge) the potentials of the gradation voltage applying lines to a predetermined value. Thus, the gradation voltage corresponding to the display data cannot be accurately generated during a period (t11) when the potential of each gradation voltage applying line varies. The accurate gradation voltage is obtained only during a time t12, which is different from the varying period t11. Accurate write operations cannot be preformed during the varying period t11. Thus, when a substantial decrease occurs in the time for which a gradation voltage is applied to the signal line S corresponding to the second switch control signal SW_R0, the application of a gradation voltage to the signal line S corresponding to the second switch control signal SW_R0 is insufficient compared to that to the signal lines S corresponding to the other second switch control signals SW_G0 and SW_B0 (insufficient write of the display data signal). That is, the gradation voltage is not sufficiently applied to the display pixel PIX connected to the signal line S corresponding to the second switch control signal SW_R0. This results in vertical stripes in an image displayed on the liquid crystal display panel 10, thus degrading display image quality.

On the other hand, if the driving capability of the output amplifier circuit 252 is enhanced to allow a sufficient gradation voltage to be applied the signal line S even with a short application time such as that described above, power consumption disadvantageously increases.

Now, description will be given of a method for drivingly controlling the liquid crystal display apparatus in accordance with the present embodiment 1.

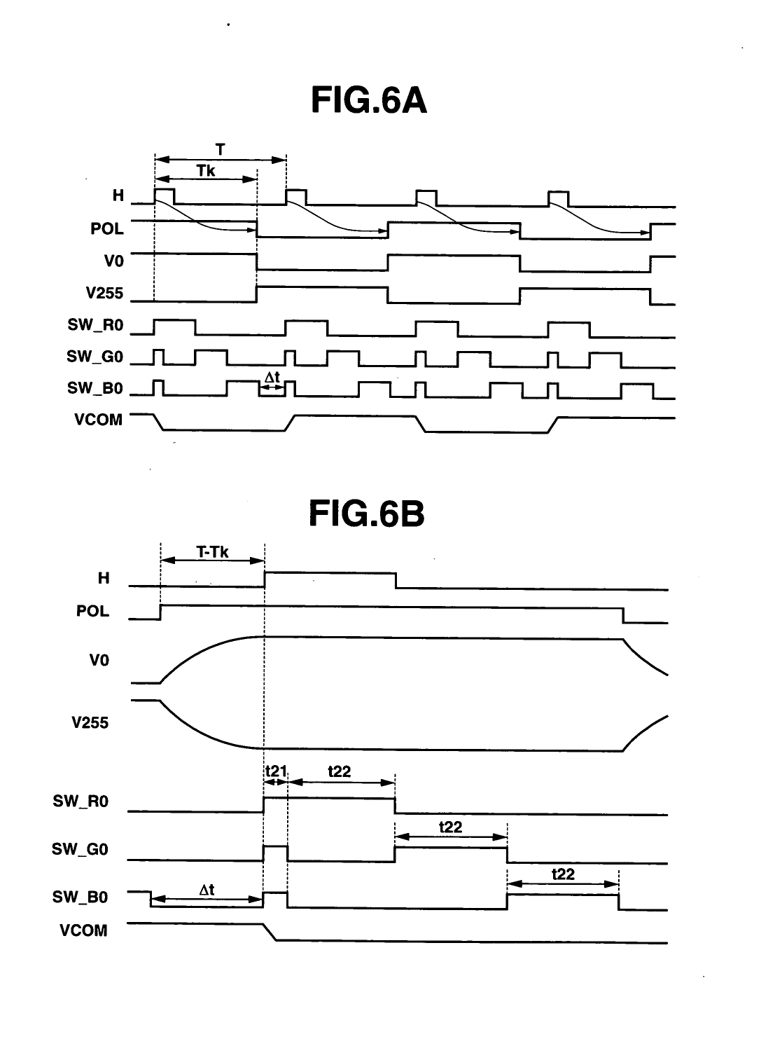

FIG. 6A is a diagram showing the signal waveforms of main signals in the liquid crystal display apparatus 1 in accordance with the present embodiment.

FIG. 6B is an enlarged view of the neighborhood of a time T (one horizontal scan period) in FIG. 6A.

In these figures, an abscissa shows the time axis. The figures show the voltage waveforms of the horizontal synchronizing signal H, the polarity control signal POL, the voltage applied to gradation voltage applying line V0, the voltage applied to the gradation voltage applying line V255, the second switch control signals SW_R0, SW_G0, and SW_B0, and the common signal voltage VCOM in this order from top to bottom.

The polarity of the conventional polarity control signal POL is reversed in response to and simultaneously with a rise in the horizontal synchronizing signal H. However, in the present embodiment, as shown in FIG. 6A, the reversal occurs a time Tk (<T) after the rise in the horizontal synchronizing signal H and after the completion of application of a gradation voltage to each signal line S during the scan period. In other words, the LCD controller 80 reverses the polarity of the polarity control signal POL the time (T−Tk) (gradation voltage convergence time) before the next rise in the horizontal synchronizing signal H and after completing the application of a gradation voltage to each signal line S during the scan period. The LCD controller 80 then outputs the polarity control signal with the reversed polarity. In the gradation voltage generating section 28, the switches 28a and 28b are turned on or off depending on the polarity reversal in the polarity control signal POL. This reverses the polarity of the gradation voltage applied to the gradation voltage applying lines V0 to V255.

The gradation voltage convergence time is required to stabilize (converge) the potential of each gradation voltage applying line after reversal in accordance with the polarity reversal in the polarity control signal POL. The gradation voltage convergence time is set in accordance with a time constant based on the load carrying capacity of the gradation voltage applying line. Further, if time division driving with three divisions is carried out, for example, as in the present embodiment, the time may be set at about ¼ T instead of T−Tk.

That is, the polarity of the polarity control signal POL is reversed the time (T−Tk) before the rise in the next horizontal synchronizing signal H. Consequently, the potential of each gradation voltage applying line is stabilized before the horizontal synchronizing signal H rises.

Moreover, during one scan period, the polarity of the polarity control signal POL is reversed after the completion of application of a gradation voltage to each signal line S. Consequently, regardless of whichever of the second control signals SW_R0, SW_G0, and SW_B0 changes to the high level in response to a rise in the horizontal synchronizing signal H, the accurate gradation voltage corresponding to the display data can be applied to the corresponding signal line S.

This makes it possible to prevent the degradation of display image quality, which may occur with the conventional technique. Further, the time for which a gradation voltage is applied (write time) can be set equal among the signal lines S (time 22). This improves display image quality. Moreover, the insufficient application of a gradation voltage to the display pixel PIX can be avoided to eliminate the need to enhance the driving capability of the output amplifier circuit 252. This makes it possible to suppress an increase in power consumption.

Moreover, an idle time At is set which starts with the completion of application of gradation voltages to the signal lines S during a certain scan period and ends with a change in one of the second control signals SW_R0, SW_G0, and SW_B0 to the high level during the succeeding scan period. The idle time At may be used to converge the potential of the display pixel PIX at a predetermined value. Alternatively, the free time At may be used for a blanking period.

Further, as shown in FIGS. 6A and 6B, all the switches in the second control signals SW_RD, SW_G0, and SW_B0 may be set to remain at the high level for the line voltage stabilized time (time t21) before the polarity of the polarity control signal POL is reversed to change one of these signals to the high level. This allows one of the gradation voltages to be applied to the corresponding signal line S. In the prior art, the signal lines S remain in a high impedance state before the polarity of the polarity control signal POL is reversed to change one of the second control signals SW_R0, SW_G0, and SW_B0 to the high level. However, the potential of the output terminal of the signal driver 20 becomes equal to that of, for example, the common signal voltage VCOM via a parasitic capacitance in the liquid crystal display panel 10. As a result, the potential of the output terminal is markedly different from that of a gradation voltage subsequently applied to the signal line S. That is, a long time is required to stabilize the potential of the signal line S after a gradation voltage has been applied to the signal line S. This disadvantageously increases the time required to perform a write operation on the display pixel PIX. Thus, one of the gradation voltages is applied to the signal line S by setting the second control signals SW_R0, SW_G0, and SW_B0 so that these signals remain at the high level for the line voltage stabilized time (time t21) before the polarity of the polarity control signal POL is reversed to change one of these signals to the high level. This voltage is not substantially different from the subsequently applied one. Thus, even if a regular gradation voltage is applied to the signal line S, the potential of the signal line can quickly become equal to that of the gradation voltage. This makes it possible to reduce the time required to perform a write operation on the display pixel PIX.

Thus, in the present embodiment, the polarity of the polarity control signal POL is reversed after the completion of application of a gradation voltage to each signal line S during one scan period and the time gradation voltage convergence time (T−Tk) before the next rise in the horizontal synchronizing signal H. This avoids the adverse effect of the time required to stabilize the potential of the gradation voltage after polarity reversal. The accurate gradation voltage corresponding to the display data can be applied to the signal line S even though one of the second control signals SW_R0, SW_G0, and SW_B0 changes to the high level in response to a rise in the horizontal synchronizing signal H. This makes it possible to prevent the degradation of display image quality. Further, the time for which a gradation voltage is applied (write time) can be set equal among the signal lines S. This improves display image quality. Moreover, the insufficient application of a gradation voltage to the display pixel PIX can be avoided to eliminate the need to enhance the driving capability of the output amplifier circuit 252. This makes it possible to suppress an increase in power consumption.

The embodiments of the present invention have been described. However, the applicable form of the present invention is not limited to the above embodiments, which may be appropriately altered. For example, in the above configuration, the first switch group 241 comprises one switch for the three display data output lines output by the data latch section 23. The second switch group 261 comprises one switch for the three signal lines S. However, one switch may be provided for two or four or more display output lines or signal lines S.

What is claimed is:

1. A display driving device which drives a display panel on the basis of-display data, the display panel having a plurality of display pixels arranged in a matrix manner adjacent to intersections of a plurality of signal lines and a plurality of scanning lines, the display driving device comprising:
a gradation voltage generating section for generating a plurality of gradation voltages corresponding to the number of gradation levels in the display data and reversing polarities of the gradation voltages at a time based on a horizontal synchronizing signal corresponding to the display data; and
an applying circuit section provided for every predetermined number of the plurality of signal lines, for generating a display signal voltage corresponding to the display data on the basis of the plurality of gradation voltages and for sequentially applying the display signal voltage to each of the predetermined number of signal lines,
wherein the time when the gradation voltage generating section reverses the polarities of the gradation voltages is set to occur before a timing for the next horizontal synchronizing signal and after completion of application of the display signal voltage to the plurality of signal lines.

2. The display driving device according to claim 1, wherein the time when the gradation voltage generating section reverses the polarities of the gradation voltages is set to occur after completion of application of the display signal voltage to the plurality of signal lines and before a predetermined gradation voltage convergence time when voltage values of the gradation voltages converge after reversal of polarities of the gradation voltages following the timing for the next horizontal synchronizing signal.

3. The display driving device according to claim 1, further comprising a data holding section for loading and holding the display data in parallel,
wherein the applying circuit section comprises a first switch circuit section for sequentially selecting each of the predetermined number of display data held in parallel in the data holding section, in accordance with the horizontal synchronizing signal, a display signal generating section for selecting one of the plurality of gradation voltages on the basis of a gradation value in the display data to generate the display signal voltage, and a second switch circuit section for sequentially selecting each of the predetermined number of signal lines in accordance with the horizontal synchronizing signal and sequentially applying the display signal voltage corresponding to the display data selected by the first switch circuit section to every predetermined number of signal lines selected, the display signal voltage being generated by the display signal generating section.

4. The display driving device according to claim 3, wherein the display data has a digital signal, and
the display signal generating section has a digital-analog converting circuit.

5. The display driving device according to claim 3, wherein the second switch circuit section has a period during which all the plurality of signal lines are set in a selected state, before one of the predetermined number of signal lines is selected.

6. A display apparatus which displays image information based on a video signal, on a display panel having a plurality of display pixels arranged in a matrix manner adjacent to intersections of a plurality of signal lines and a plurality of scanning lines, the display apparatus comprising:
a scan driving circuit for sequentially outputting a scan driving signal to the plurality of scan lines to sequentially set the display pixels in a selected state;
a polarity reversal signal generating section for outputting a reversal signal having a polarity reversed at a time corresponding to a horizontal synchronizing signal based on the video signal; and
a signal driving circuit comprising a gradation voltage generating section for generating a plurality of gradation voltages corresponding to the number of gradation levels in display data based on the video signal and reversing polarities of the gradation voltages in response to a polarity reversal timing in the reversal signal, and an applying circuit section for every predetermined number of the plurality of signal lines, for generating a display signal voltage corresponding to the display data on the basis of the plurality of gradation voltages and for sequentially applying the display signal voltage to each of the predetermined number of signal lines,
wherein the time when the polarity reversal signal generating section reverses the reversal signal is set to occur before a timing for the next horizontal synchronizing signal and after completion of application of the display signal voltage to the plurality of signal lines.

7. The display apparatus according to claim 6, wherein the time when the polarity reversal signal generating section reverses the reversal signal is set to occur after the applying circuit section completes applying the display signal voltage to the plurality of signal lines and before a predetermined gradation voltage convergence time when voltage values of the gradation voltages converge after reversal of polarities of the gradation voltages following the timing for the next horizontal synchronizing signal.

8. The display apparatus according to claim 6, wherein the signal driving circuit further comprises data holding section for loading and holding the display data in parallel,
wherein the applying circuit section comprises a first switch circuit section for sequentially selecting each of the predetermined number of display data held in parallel in the data holding section, in accordance with the horizontal synchronizing signal, a display signal generating section for selecting one of the plurality of gradation voltages on the basis of a gradation value in the display data to generate the display signal voltage, and a second switch circuit section for sequentially selecting each of the predetermined number of signal lines in accordance with the horizontal synchronizing signal and sequentially applying the display signal voltage corresponding to the display data selected by the first switch circuit section to every predetermined number of signal lines selected.

9. The display apparatus according to claim 8, wherein the display data has a digital signal, and
the display signal generating section has a digital-analog converting circuit.

10. The display apparatus according to claim 8, wherein the second switch circuit section has a period during which all the plurality of signal lines are set in a selected state, before one of the predetermined number of signal lines is selected.

11. A method for driving a display driving device which drives a display panel on the basis of display data, the display panel having a plurality of display pixels arranged in a matrix manner adjacent to intersections of a plurality of signal lines and a plurality of scanning lines, the method comprising:
generating a plurality of gradation voltages corresponding to the number of gradation levels in the display data;
generating a display signal voltage corresponding to the display data based on the plurality of gradation voltages;
sequentially applying the display signal voltage to each of the predetermined number of signal lines, reversing the polarities of the gradation voltages before a timing for the next horizontal synchronizing signal and after completion of application of the display signal voltage to the plurality of signal lines.

12. The method for drivingly controlling a display driving device according to claim 11, wherein in reversing the polarities of the gradation voltages, the time when the polarities of the gradation voltages are revered is set to occur after completion of application of the display signal voltage to the plurality of signal lines and before a predetermined gradation voltage convergence time when voltage values of the gradation voltages converge after reversal of polarities of the gradation voltages following the timing for the next horizontal synchronizing signal.

13. The method for drivingly controlling a display driving device according to claim 11, wherein said generating the display signal voltage comprises loading and holding the display data in parallel, sequentially selecting each of the predetermined number of display data held, in accordance with the horizontal synchronizing signal, and selecting one of the plurality of gradation voltages on the basis of a gradation value in the display data to generate the display signal voltage, and
said sequentially applying the display signal voltage to each of a predetermined number of the plurality of signal lines comprises sequentially selecting each of the predetermined number of signal lines in accordance with the horizontal synchronizing signal and sequentially applying the display signal voltage to every predetermined number of signal lines selected.

14. The method for drivingly controlling a display driving device according to claim 13, wherein said sequentially applying the display signal voltage comprises setting all the plurality of signal lines in a selected state before one of the predetermined number of signal lines is selected.
